(19) United States
(12) Patent Application Publication
(10) Pub. No.: US 2017/0179565 A1
(43) Pub. Date: Jun. 22, 2017

(54) Microstrip Line Directional Coupler

(71) Applicants: Noureddine N.O. Outaleb, Ottawa (CA); Tonatiu Abrego, Kanata (CA)

(72) Inventors: Noureddine N.O. Outaleb, Ottawa (CA); Tonatiu Abrego, Kanata (CA)

(73) Assignee: Alcatel-Lucent Canada Inc., Ottawa (CA)

(21) Appl. No.: 15/381,086

(22) Filed: Dec. 15, 2016

Related U.S. Application Data
(60) Provisional application No. 62/268,196, filed on Dec. 16, 2015.

(51) Int. Cl. H01P 5/18; H01P 11/00; H01P 3/08

(52) U.S. Cl. CPC H01P 5/184; H01P 3/08; H01P 11/003

(57) ABSTRACT

An apparatus, e.g. a radio-frequency (RF) coupler, includes first and second microstrip lines. First and second coupling fingers extend from the first microstrip line into the space, and a third coupling finger extends from the second microstrip line into the space about centered between the first and second coupling fingers. Fourth and fifth coupling fingers extend from the first microstrip line into the space, and a sixth coupling finger extends from the second microstrip line into the space about centered between the fourth and fifth coupling fingers. The second and fourth coupling fingers are adjacent each other with a distance between them along the first transmission line exceeding a distance between the first and second coupling fingers along the first transmission line by at least a factor of about two.

### TECHNICAL FIELD

The present invention relates generally to the field of radio-frequency (RF) signal processing, and, more particularly, but not exclusively, to methods and apparatus for coupling a signal in an RF circuit.

### BACKGROUND

This section introduces aspects that may be helpful to facilitate a better understanding of the inventions. Accordingly, the statements of this section are to be read in this light and are not to be understood as admissions about what is in the prior art or what is not in the prior art. Any techniques or schemes described herein as existing or possible are presented as background for the present invention, but no admission is made thereby that these techniques and schemes were heretofore commercialized, or known to others besides the inventors.

Some conventional microstrip couplers provide poor directivity because of the phase velocity mismatch between the odd and the even propagation modes. Typically, microstrip line devices operate in an inhomogeneous dielectric environment, in which a substrate provides one dielectric permittivity and air provides another dielectric permittivity. This dielectric difference may manifest itself in microstrip couplers as poor directivity. Moreover, the microstrip coupler directivity is expected to further decrease becoming coupling between the strip lines decreases. Improved couplers are needed that provide better matching between these modes and provide greater directivity.

### SUMMARY

The inventors disclose various apparatus and methods that may be beneficially applied to, e.g., radio-frequency (RF) signal processing, e.g. RF transmission and reception. While such embodiments may be expected to provide improvements in performance of such apparatus and methods, no particular result is a requirement of the present invention unless explicitly recited in a particular claim.

One embodiment provides an apparatus, e.g. a radio-frequency (RF) coupler. The apparatus includes a first microstrip line formed on a dielectric surface, and a second microstrip line formed on said surface about parallel to said first microstrip line. The first and second microstrip lines are separated by a space, or gap (Dₛ). First and second coupling fingers are connected to said first microstrip line, and extend into the gap. A third coupling finger is connected to said second microstrip line, and extends into the gap. The third coupling finger is about centered between said first and second coupling fingers. Fourth and fifth coupling fingers are connected to said first microstrip line, and extend into said space. A sixth coupling finger is connected to said second microstrip line. The sixth coupling finger extends into said space, and is about centered between said fourth and fifth coupling fingers. The second and fourth coupling fingers are adjacent each other along the first microstrip line, and a distance between said second and fourth coupling fingers along the first transmission line exceeds a distance between said first and second coupling fingers along said first transmission line by at least a factor of about two.

In various embodiments a sum of a length of the first and third coupling fingers, e.g. D1+D2, is no greater than a distance Dₛ between the first and second microstrip lines. In various embodiments D1+D2 is greater than Dₛ. In various embodiments D1+D2 is between about 1.0 and about 1.4 times Ds. In some embodiments the distance Dₛ between the first and second microstrip lines is about 1.25 mm, the length D₁ of the first coupling finger is about 0.79 mm, and the length D₂ of the third coupling finger is about 0.57 mm. In some embodiments the first microstrip line has a width of about 0.67 ·Dₛ or less. In some embodiments the second microstrip line has a width of about 0.70 ·Dₛ or less. In some embodiments the first coupling finger is spaced about 1.125 mm from the second coupling finger along the first microstrip line. In any of the above embodiment the first microstrip line may be coupled to a transmitter configured to provide a signal having a frequency in a range between about 1800 MHz and about 2200 MHz. In some embodiments the substrate comprises alumina, and in some such embodiments comprises Rogers Laminate 4350B. In some embodiments the coupling between first and second ends of the second microstrip line about −29.3 dB at 1950 MHz.

Another embodiment provides an apparatus, e.g. an RF coupler, that includes first and second microstrip lines formed on a dielectric substrate surface about parallel to each other and separated by a space. First and second stubs project from the first microstrip line into the space, and have a gap between them. A third stub projects from the second microstrip line into the space between the microstrip lines, and is about centered between the first and second stubs, but does not extend into the gap.

Other embodiments provide various methods, e.g. of manufacturing a radio-frequency (RF) coupler, according to any of the preceding embodiments.

### BRIEF DESCRIPTION OF THE DRAWINGS

A more complete understanding of the present invention may be obtained by reference to the following detailed description when taken in conjunction with the accompanying drawings wherein:

FIG. 1 illustrates an example embodiment of an apparatus, e.g. a microstrip-line directional coupler, including port assignments;

FIG. 2 illustrates the apparatus of FIG. 1 with a first set of dimensions marked;

FIG. 3 illustrates the apparatus of FIG. 1 with a second set of dimensions marked;

FIGS. 4a-4f illustrate modeled performance characteristics of one embodiment of the coupler illustrated in FIG. 1, as configured in FIG. 5; and

FIG. 5 illustrates the coupler of FIG. 1 integrated with a packaging structure, the combined structure used to model performance of the coupler.

### DETAILED DESCRIPTION

Various embodiments are now described with reference to the drawings, wherein like reference numbers are used to refer to like elements throughout. In the following description, for purposes of explanation, numerous specific details are set forth in order to provide a thorough understanding of one or more embodiments. It may be evident, however, that such embodiment(s) may be practiced without these specific details.

Some microstrip-line directional couplers use shunt capacitors between two coupled lines. Reducing the size of such couplers is difficult. It is believed that this difficulty is based, at least in part, on the difficulty of matching odd and even propagation modes in the coupler. The inventor has discovered that a shunt structure that employs two stubs projecting from one microstrip line into the space between the lines, and one stub projecting from the other of the microstrip lines into the space advantageously provides an impedance (reactance) that effectively matches phase velocities of odd and even propagation modes in a frequency range of commercial interest, e.g. a broadband frequency range. The coupler design can simultaneously cover DCS band (between about 1805 MHz and about 1880 MHz, PCS band (between about 1930 MHz and about 1995 MHz) and about AWS band (between about 2110 MHz and about 2170 MHz). The ability to match the phases of the odd and the even propagation modes provides the ability to enhance the directivity of the microstrip line coupler while keeping the size of the coupler small to a degree not known to be possible without these shunt structures.

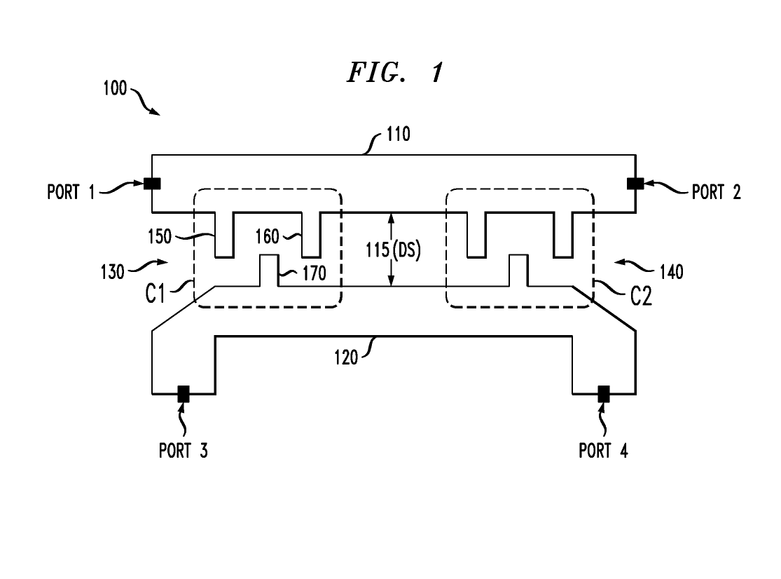

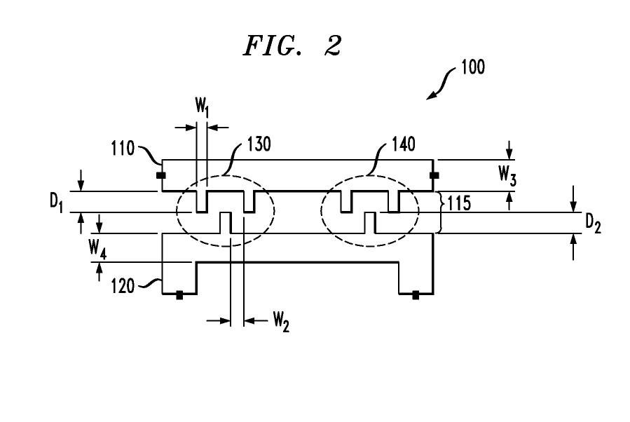

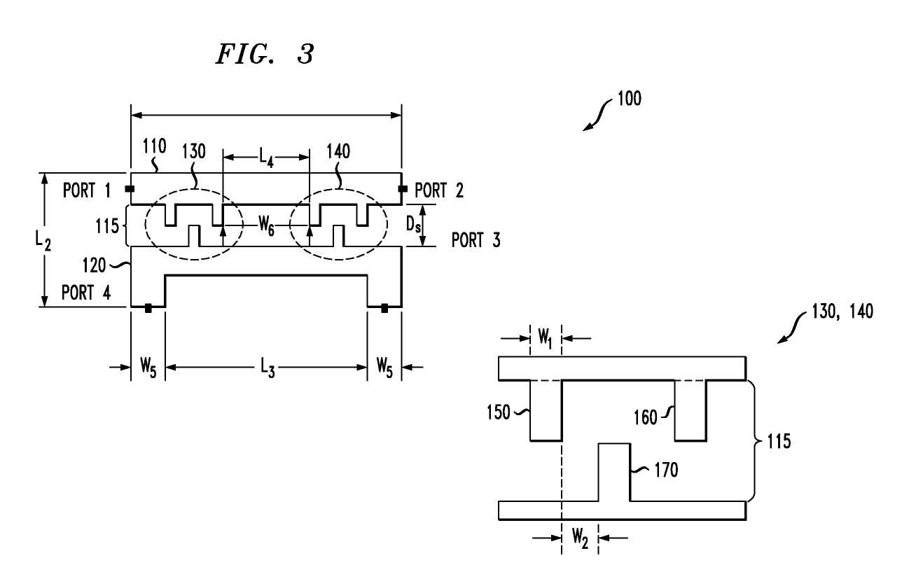

FIG. 1 illustrates an example embodiment of an apparatus, e.g. a microstrip-line directional coupler 100, including port assignments, four ports P1, P2, P3 and P4. Port P1 may be referred to as an input port, port P2 may be referred to as a transmitted port, port P3 may be referred to as a coupled port, and port P4 may be referred to as an isolated port. FIG. 2 illustrates the coupler 100 with a first set of dimension callouts, and FIG. 3 illustrates the coupler 100 with a second different set of dimension callouts to reduce clutter. Therefore, FIGS. 1 and 2 are referenced concurrently. The coupler 100 may operate as a 30 dB coupler in a useful portion of the microwave band, e.g. between about 1800 MHz and about 2200 MHz. Those skilled in the pertinent art will appreciate that “operating as a 30 dB coupler” implies the coupling between the input port P1 and the coupled port P3 is about −30 dB. The coupler may be formed on any dielectric substrate, e.g. glass-reinforced epoxy laminate (FR-4), Rogers 4350B Laminate or alumina. Referring to FIG. 1, the coupler 100 includes first and second microstrip lines 110, 120 separated by a gap 115 having a width Dₛ. The coupler 100 may be understood as a four-port device with ports 1-4 assigned as shown. For the purpose of this discussion, and without limitation, port 1 is assumed to be the input port and port 2 is assumed to be the output port. The coupler 100 further includes a first mode-equalizing structure 130 positioned close to one end of the coupled lines 110, 120, e.g. the input port P1, and a second mode-equalizing structure 140 positioned close to the other end of the coupled lines 110, 120, e.g. the output port P2. Each mode-equalizing structure 130, 140 includes three stubs projecting into the space between the coupled lines 110, 120.

The following discussion focuses on the mode equalizing structure 130, recognizing that the principles are applicable also to the mode phase velocity-equalizing structure 140. By “mode equalizing”, it is meant that the structure 130 provides phase velocity equalization between odd and even propagation modes. The mode equalizing structure 130 includes three stubs, or coupling fingers, 150, 160 and 170. The stubs 150 and 160 project from the microstrip line 110 into the gap 115, while the stub 170 projects from the microstrip line 120 into the gap 115. The stub 170 is about centered between the stubs 150 and 160. Notably there may be little or no overlap between the stubs 150, 160 and the stub 170.

Some known couplers use interdigitated lines between coupled strip lines as shunt capacitors. The inventors have determined that the impedance provided by such capacitors impose a barrier to compact coupler designs having a coupled line length significantly less than a quarter wavelength of the intended operating frequency, e.g. on the order of one tenth the wavelength. The impedance between lines of an interdigitated capacitor includes a distributed capacitance contribution and a distributed inductance contribution. These two impedance contributions are mixed, in that an incremental length δx of two coupled interdigitated lines includes a δC (incremental capacitance) portion and a δL (incremental inductance) portion. Thus in an interdigitated design, the capacitance contribution cannot be increased without also increasing the inductance contribution. The inventors have discovered that by using a small number of capacitively-coupled stubs such as the stubs 150-170, and by providing little or no overlap between the stubs 150, 160 and the stub 170, the capacitance contribution of the structure 130 behaves substantially as a very small lumped capacitor element, e.g. having a capacitance value <=20 fF, with a negligible inductive component. It is believed that the small capacitance value in the absence of significant inductance provides the ability to reduce the length of the coupled lines to a small fraction of the signal wavelength. For instance, such small capacitance value is the result of the capacitive coupling between the stubs 150, 160 and the stub 170 which is primarily fixed by fringing fields at the ends of the stubs. The inductance of the stubs is understood to remain distributed along each stub, but is not mixed with a distributed capacitance to a significant extent.

The stubs 150, 160 have a length D₁, and the stub 170 has a length D₂. It may be preferable that the stubs 150, 160 do not overlap the stub 170, such that D₁+D₂<Dₛ. However, it is expected that the described benefit may be obtained with an overlap as much as about 30% of Dₛ. In some embodiments the combined length of the stub 150 and the stub 170 D₁+D₂ is between about 1.0 and about 1.4 times a distance between the first microstrip line 110 and the second microstrip line 120 (Ds).

Table I presents nominal values of a nonlimiting example of a 30 dB coupler fabricated according to the principles described above on Rogers Laminate 4350B dielectric with 0.508 mm height and relative permittivity εᵣ=3.66, with air above. Thus the coupler experiences a heterogeneous dielectric environment. The resulting modeled equivalent capacitances of C1 and C2 are, respectively, about 16.15 fF and about 16.28 fF. The tabulated dimensions may configure the coupler 100 to operate in a frequency band ranging between about 1800 MHz and about 2200 MHz.

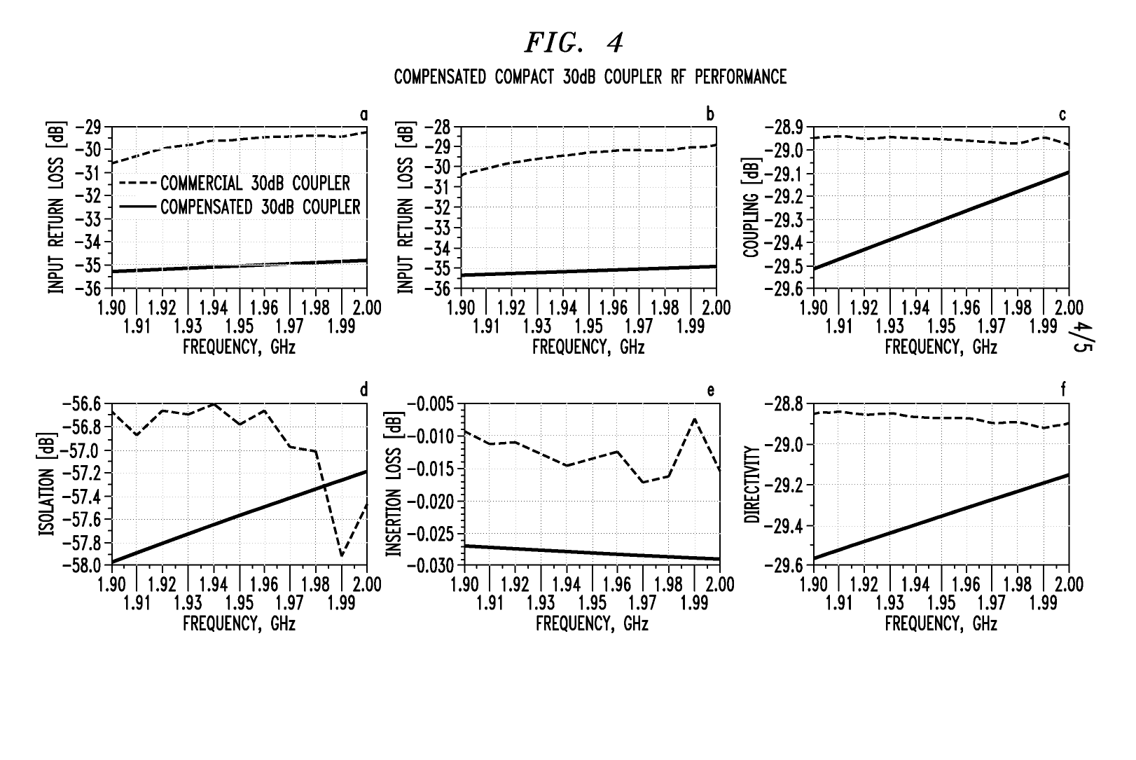

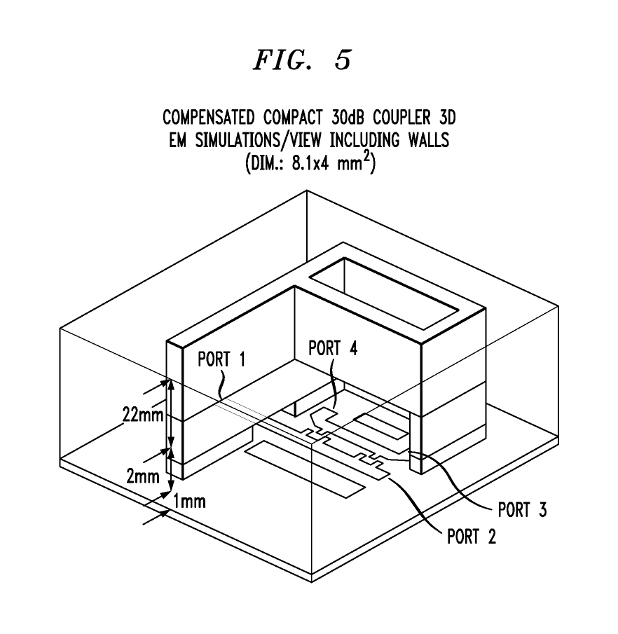

FIGS. 4a-4f present modeled performance characteristics of an embodiment of a coupler consistent with the disclosure, e.g. FIGS. 1-3 and Table I. The local environment of the modeled coupler is illustrated in FIG. 5, which shows a partial enclosure such as may optionally be used to shield the modeled coupler when installed in an operating RF circuit. Each of the charts shown in FIGS. 4a-4f includes example performance characteristics of the modelled 30 dB coupler (solid lines) as compared with a conventional (commercial) 30 dB coupler (dashed lines), and are presented without implied limitation. The conventional 30 dB coupler is represented by, e.g. Anaren Model X3C19P2-30S, which includes a stripline formed such that the conductive elements are placed within a homogenous dielectric environment. FIG. 4a and FIG. 4b respectively illustrate input and output return losses better than 34.5 dB. FIG. 4c shows a coupling of this particular embodiment of ˜29.3 dB at a center frequency of about 1950 MHz, while FIGS. 4d and 4e show the simulated isolation and insertion losses of the coupler, respectively. FIG. 4f demonstrates a directivity better than 29 dB for the particular embodiment between about 1900 MHz and about 2000 MHz. It is clear that the modeled operating characteristics of the coupler 100 are comparable or superior to the characteristics of the conventional coupler, thus validating the benefit of the described features, e.g. the structures 130, 140. In particular, the coupling (FIG. 4c) ranges between about −29.5 dB and about −29.1 dB in a corresponding frequency range between about 1900 MHz and about 2000 MHz. This variation is well within the tolerance of many RF circuits to operate effectively, thus demonstrating adequate phase matching of even and odd propagation mode phase velocities.

TABLE I
(all dimensions in mm)

| | |
|---|---|
| W₁ | 0.3000 |
| W₂ | 0.4125 |
| W₃ | 0.9750 |
| W₄ | 0.8455 |
| W₅ | 1.0550 |
| W₆ | 0.7333 |
| D₁ | 0.7883 |
| D₂ | 0.5683 |
| Dₛ | 1.2500 |
| L₁ | 8.11, min 6, max 28.11 |
| L₂ | 4.0000 |
| L₃ | 5-25 |
| L₄ | 0.7333 |
| C1 | 16.15 fF |
| C2 | 18.28 fF |

The implementation of Table I is but one example of embodiments within the scope of the description and the claims. All the dimensions may be scaled within the limits of manufacturing technology to dimensions that are determined in part by the type, the height and the dielectric constant of the dielectric substrate on which the microstrip line is formed. The described embodiment may be scaled to target other operating frequency ranges, e.g. from about 600 MHz for low frequency applications to about 2200 MHz or higher for high frequency applications. Moreover, with dimensional changes that may be determined without undue experimentation, the coupling between the input port P1 and the coupled port P3 may be a value other than −30 dB, e.g. −20 dB or −10 dB.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
a first microstrip line formed on a dielectric surface;
a second microstrip line formed on said surface about parallel to said first microstrip line and separated from said first microstrip line by a space (Dₛ);
first and second coupling fingers connected to said first microstrip line and extending into said space;
a third coupling finger connected to said second microstrip line, extending into said space and being about centered between said first and second coupling fingers;
fourth and fifth coupling fingers connected to said first microstrip line and extending into said space; and
a sixth coupling finger connected to said second microstrip line extending into said space and being about centered between said fourth and fifth coupling fingers,
wherein said second and fourth coupling fingers are adjacent each other and a distance between said second and fourth coupling fingers along said first transmission line exceeds a distance between said first and second coupling fingers along said first transmission line by at least a factor of about two.

2. The apparatus of claim 1, wherein a sum of a length of the first and third coupling fingers is no greater than a distance between said first and second microstrip lines.

3. The apparatus of claim 1, wherein a sum of a length of the first and third coupling fingers is greater than a distance between said first and second microstrip lines.

4. The apparatus of claim 1, wherein a combined length of the first and third coupling fingers is between about 1.0 and about 1.4 times a distance between said first and second microstrip lines.

5. The apparatus of claim 1, wherein the distance Dₛ between said first and second microstrip lines is about 1.25 mm, a length D₁ of the first coupling finger is about 0.79 mm, and a length D₂ of the third coupling finger is about 0.57 mm.

6. The apparatus of claim 1, wherein said first microstrip line has a width of about 0.78·Dₛ or less.

7. The apparatus of claim 1, wherein said second microstrip line has a width of about 0.68·Dₛ or less.

8. The apparatus of claim 1, wherein said first coupling finger is spaced about 1.125 mm from said second coupling finger.

9. The apparatus of claim 1, wherein said first microstrip line is coupled to a transmitter configured to provide a signal having a frequency in a range between about 1800 MHz and about 2200 MHz.

10. The apparatus of claim 1, wherein said substrate comprises alumina.

11. The apparatus of claim 1, wherein said substrate comprises Rogers Laminate 4350B.

12. The apparatus of claim 1, wherein a coupling between first and second ends of said second microstrip line is about −29.3 dB at about 1950 MHz.

13. A method, comprising
forming a first microstrip line over a dielectric surface;
forming a second microstrip line over said surface about parallel to said first microstrip line and separated from said first microstrip line by a space (Dₛ);
connecting first and second coupling fingers to said first microstrip line and extending into said space;
connecting a third coupling finger to said second microstrip line, extending into said space and being about centered between said first and second coupling fingers;
connecting fourth and fifth coupling fingers to said first microstrip line and extending into said space; and
connecting a sixth coupling finger to said second microstrip line extending into said space and being about centered between said fourth and fifth coupling fingers,
wherein said second and fourth coupling fingers are adjacent each other and a distance between said second and fourth coupling fingers along said first transmission line exceeds a distance between said first and second coupling fingers along said first transmission line by at least a factor of about two.

14. The method of claim 13, wherein a sum of a length of the first and third coupling fingers is no greater than a distance between said first and second microstrip lines.

15. The method of claim 13, wherein a sum of a length of the first and third coupling fingers is less than a distance between said first and second microstrip lines.

16. The method of claim 13, wherein a sum of a length of the first and third coupling fingers is less than about 0.85 times a distance between said first and second microstrip lines (Ds).

17. The method of claim 13, wherein the distance Dₛ between said first and second microstrip lines is about 1.25 mm, a length D₁ of the first coupling finger is about 0.7883 mm, and a length D₂ of the second coupling finger is about 0.5683 mm

18. The method of claim 13, wherein said first microstrip line has a width of about 0.78·Dₛ or less.

19. The method of claim 13, wherein said second microstrip line has a width of about 0.68·Dₛ or less.

20. The method of claim 13, wherein said first coupling finger is spaced about 0.4125 mm from said second coupling finger.

21. The method of claim 13, wherein said first microstrip line is coupled to a transmitter configured to provide a signal having a frequency in a range between about 1800 MHz and about 2200 MHz.

22. The method of claim 13, wherein said substrate comprises alumina.

23. The method of claim 13, wherein said substrate comprises Rogers Laminate 4350B.

24. The method of claim 13, wherein a coupling between first and second ends of said second microstrip line about −29.3 dB at 1950 MHz.
